(19) United States
(12) Patent Application Publication
(10) Pub. No.: US 2023/0389747 A1
(43) Pub. Date: Dec. 7, 2023

(54) Machine for Preparing Coffee Beverages

(71) Applicant: DE' LONGHI APPLIANCES S.R.L. CON UNICO SOCIO, Treviso (IT)

(72) Inventors: Paolo Evangelisti, Treviso (IT); Nicola Piovan, Treviso (IT); Davide Bonotto, Treviso (IT); Alberto Acciari, Treviso (IT)

(73) Assignee: DE' LONGHI APPLIANCES S.R.L. CON UNICO SOCIO, Treviso (IT)

(21) Appl. No.: 18/034,704

(22) PCT Filed: Oct. 26, 2021
(86) PCT No.: PCT/IT2021/050346

§ 371 Date: Apr. 29, 2023

(30) Foreign Application Priority Data
Oct. 29, 2020 (IT) 102020000025648

(51) Int. Cl. A47J 31/46; A47J 31/44; A47J 31/36

(52) U.S. Cl. CPC A47J 31/469; A47J 31/461; A47J 31/36; A47J 31/4496

(57) ABSTRACT

An automatic machine for preparing coffee beverages includes a brewing unit provided with a brewing chamber connected to a feed circuit for the water by means of an entry aperture and to an exit circuit for the beverage by means of an exit aperture. The machine also includes a valve unit, connected to the exit circuit and configured to supply a first high-pressure exit path and a second low-pressure exit path for the beverage. The invention also concerns a method to prepare a coffee beverage.

### FIELD OF THE INVENTION

Embodiments described here concern an automatic machine for preparing coffee beverages, in particular an automatic machine, which allows to prepare beverages both at low pressure, without the presence of cream, as required for the preparation of a coffee beverage of the “drip coffee” type, and also under pressure, with the presence of cream, that is, beverages having the organoleptic characteristics of an “Espresso” type coffee beverage.

### BACKGROUND OF THE INVENTION

Coffee machines are known for preparing American coffee, also called “drip coffee machines”, comprising a water tank, a boiler, a brewing chamber in which a filter is positioned and into which on each occasion the coffee powder is introduced, and a receptacle located under the brewing chamber to receive the beverage.

The water heated by the boiler is fed to the brewing chamber where, due to the effect of the force of gravity, it percolates through the coffee powder, extracting the aromatic substances from it in order to obtain the coffee beverage that is collected in the receptacle.

Traditional “drip” type coffee machines have a simple construction, and a low production cost. One disadvantage of traditional machines is that they require manual intervention by the user both to load the coffee powder and also to remove it when the beverage has been prepared.

Automatic machines for preparing coffee beverages are also known, which comprise a water tank, a boiler, and a brewing chamber into which a dose of coffee powder is introduced on each occasion, and into which hot water is injected in order to extract the aromatic substances from the coffee powder.

Known automatic machines are mainly intended for preparing “Espresso” type coffee, and are therefore designed to operate at high pressure.

Even though these machines allow to prepare a “long”, “Americana” type of coffee, it does not have the characteristics of a “drip” type coffee, as it is obtained by preparing an Espresso coffee to which a certain quantity of hot water is added.

In machines intended for the preparation of “Espresso” coffee, however, downstream of the brewing chamber there is normally a cream whipper valve, the purpose of which is to increase the exit pressure of the coffee beverage, generating turbulence in the flow, with the consequent formation of air bubbles and froth that form the typical cream of a good quality Espresso.

As known, the two types of beverages “Espresso” and “Drip” coffee have to meet certain specific requirements in order to be considered of high quality, which are often in contrast with each other.

While in the case of an “Espresso” coffee it is required that a layer of froth, or cream having a certain consistency and color must be formed on top of the beverage, in the case of a “Drip” coffee, it is required that it must be free of any air bubbles, as is normally the case for coffee prepared by percolation.

To at least partly solve these problems, in known automatic machines there are regulation devices by means of which it is possible to vary the back pressure of the cream whipper valve, and therefore the pressure inside the extraction chamber.

However, these regulation devices are generally complex and not very efficient. Moreover, due to the residues of coffee beverage that are deposited in the cream whipper valve, it has a limited useful life, requiring frequent cleaning and descaling operations.

Lately, automatic machines for preparing “long” coffee, or “Drip” type coffee, have also been spreading on the market, which operate at low pressure and are therefore not suitable for preparing “Espresso” coffee.

However, in the field of machines for preparing coffee beverages, increasingly versatile machines are required, which allow a consumer to be able to prepare different types of beverages in a substantially automatic manner, without it being necessary to carry out any calibration or regulation of the machine.

Furthermore, consumers are increasingly attentive to the quality of the beverages delivered, which must therefore comply with respective standards based on the different types with regard to the presence or absence of froth, intensity of taste, quantity of dissolved solids, or other evaluation parameters.

Some coffee making machines are for example described in US 2014/150664 A1, US 2008/276807A1, US 2013/014649 A1 and US 2013/295244 A1.

One purpose of the present invention is to provide a machine for preparing coffee beverages, which is optimized both for preparing American type coffee at low pressure, and also for preparing Espresso type coffee at high pressure.

Another purpose of the present invention is to provide a machine for preparing coffee beverages which allows to obtain a “Drip” type coffee or Americano, with characteristics similar to those obtainable by means of traditional percolation machines and which respects the standards required for this type of beverage.

Another purpose of the present invention is to provide a machine for preparing coffee beverages which allows to obtain an Espresso type coffee with characteristics similar to those obtainable by means of traditional type machines.

Another purpose is to provide a super-automatic machine for preparing coffee which is reliable and does not require manual loading and unloading of the coffee powder by the user.

Another purpose of the present invention is to provide a machine which requires little maintenance, and which is simple to clean.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a machine for preparing coffee beverages according to the invention comprises a brewing unit provided with a brewing chamber suitable to receive and contain a dose of coffee powder, a first circuit for feeding the brewing water, by means of which heated water is fed to the brewing chamber, and a second exit circuit for the beverage.

The water feed circuit and the beverage exit circuit are connected to respective entry and exit apertures of the brewing chamber.

A feed pump and a heating device, for example a boiler, can be disposed along the first feed circuit between the water source and the brewing chamber.

There can also be provided detection devices suitable to detect one or more parameters of the flow of water being fed, such as for example a flow meter, a volumetric dispenser, or temperature sensors.

According to one aspect of the present invention, the machine comprises a valve unit provided with an entry connected to the exit circuit and an exit connected to a beverage delivery duct.

The valve unit defines a high-pressure exit path for the transit of an “Espresso” type coffee beverage, and a low-pressure exit path for the transit of a “Drip coffee” type coffee beverage. The valve unit comprises counter pressure means suitable to supply a desired counter pressure force, and bypass means selectively drivable in order to bypass the action of the counter pressure means.

In this way, an optimal preparation of both types of beverages is guaranteed. In fact, for “Espresso” type beverages it is ensured that these have sufficient pressure to contrast the counter pressure means, while for “Coffee” type beverages an exit passage is defined that is substantially free of obstructions and obstacles that could generate unwanted turbulences.

According to some embodiments, the high-pressure path and the low-pressure path are respectively defined by a first branch and a second branch of the valve unit, which separate from the exit circuit and re-join each other in the delivery duct upstream of the delivery nozzle.

According to these embodiments, the counter pressure means comprise a cream whipper valve disposed along the first branch and the bypass means comprise an interception valve which can be selectively activated to open or close the second branch.

According to some embodiments, the interception valve is made as a solenoid valve commandable by means of a control and command unit of the machine as a function of a selection made by a consumer in relation to a beverage to be prepared.

According to some variants, the high-pressure path and the low-pressure path are defined by, and share, a single branch within the valve unit. According to these embodiments, the counter pressure means comprise a cream whipper valve and the bypass means comprise drive means selectively commandable to keep the cream whipper valve in the completely open position.

According to these embodiments, the “Espresso” coffee and the “Drip” coffee transit along a same duct; however, while in the case of the Espresso coffee the cream whipper valve is active and allows the passage of liquids only if the pressure exceeds a threshold value, in the case of the “Drip” coffee the cream whipper valve is in a non-active condition.

This conformation of the machine, which provides both a “low-pressure” exit path and also a “high-pressure” exit path for the beverage, allows to prepare respective beverages with organoleptic characteristics corresponding to those of beverages normally classified as “Drip” and “Espresso”/“Coffee” and defined by predefined standard parameters.

For example, in the case of “Drip” beverages, the SCA or ECBC certification standards provide the following parameters:
between 50 g and 60 g of coffee per liter of beverage;
brewing temperature comprised between 92° C. and 96° C.;
extraction speed between 4 and 8 min.

The double exit path allows to control the machine in such a way as to regulate in a suitable and differentiated way the quantity of coffee powder used for each single dose of beverage and the speed at which the water is fed through the coffee powder, as a function of the beverage to be prepared. For example, in the case of a “Drip” coffee, it can be provided to feed the water with a flow rate comprised between about 2-2.2 cc/sec and 4-4.2 cc/sec, in order to comply with the standard that requires a liter of beverage to be delivered between 4 and a maximum of 8 minutes (and corresponding proportions, e.g. 0.5 liters in 2-4 minutes), so as to ensure a correct extraction of the aromas, and a total percentage of dissolved solids comprised between about 1.30% and 1.55%.

In the case of an “Espresso” type beverage, it is required that the beverage be prepared under pressure and that there be a layer of cream having a determinate thickness and color. In order to ensure that these characteristics are achieved, it is possible on the one hand to increase the quantity of coffee powder per dose of beverage, for example up to 10-12 g, and on the other hand to reduce the water flow rate, for example to approximately 1 cc/sec, so that it remains in contact with the coffee powder for a longer period of time. Furthermore, the coffee powder can be compressed, so as to increase the pressure in the brewing chamber compared to what is provided for the “Drip” type coffee. In this way, thanks to the combination of a greater quantity of coffee powder and a slower delivery compared to traditional solutions of machines for preparing “Espresso” coffee, it allows to obtain a coffee beverage with organoleptic characteristics similar to those of a traditional “Espresso” coffee even with a smaller working pressure compared to the 10 bar normally used in such machines.

According to some embodiments, rapid connection elements with a constant section can be provided for the connection with the respective valves and/or solenoid valves, in particular along the exit circuit and the beverage delivery circuit downstream of the brewing chamber. In this way, the exit duct for the beverages has a passage section substantially free of variations in diameter, so that the flow is not subjected to any turbulence which could lead, in the case of a “Drip” coffee, to the generation of unwanted air bubbles and cream, while in an “Espresso” coffee it could deteriorate the quality of the cream.

According to some embodiments, the machine comprises a delivery valve located upstream of the brewing chamber and configured to regulate the feed pressure of the brewing water.

According to some embodiments, one of either, or both, the cream whipper valve and the delivery valve can be made with a valve device having a double function, namely a non-return and anti-limescale function.

The valve device comprises a housing provided with an entry aperture and an exit aperture, a piston mobile with respect to the exit aperture between a closing position, in which it prevents the transit of liquids through the valve device, and an opening position, in which it allows the passage of the liquids, and elastic return means configured to keep the valve device in the closed position until a predefined pressure limit is reached.

According to an advantageous embodiment, the path for the fluid is defined by a channel disposed inside the mobile piston and the elastic means are located outside the latter. In this way, possible accumulations of limescale between the coils of the spring are prevented. In addition, the disposition of the elastic means outside the path of the fluid makes the latter easy to clean, so that the valve device is also suitable to be used as a cream whipper valve.

The valve devices in which the elastic means are normally disposed along the path of the flow have the disadvantage that limescale can deposit on the coils of the springs, thus reducing their performance and requiring frequent descaling operations to be performed. Furthermore, in the event that a coffee beverage has to pass through these valve devices, the solids dissolved in the beverage, which are notoriously resistant and tend to generate a lot of dirt, can also deposit on the elastic elements, making cleaning operations complex.

According to possible solutions, the machine comprises a self-priming valve disposed along a discharge pipe of the pump, deriving from the water feed circuit, the self-priming valve being selectively drivable in order to put the pump in communication with the discharge aperture, allowing any air bubbles present therein to escape. According to a preferred embodiment, the self-priming valve is driven directly by the movement of the mobile brewing unit.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic view of a machine for preparing coffee beverages in accordance with a first embodiment of the invention;

FIG. 1a is a schematic view of a detail of the machine of FIG. 1 according to a variant;

FIG. 2 is a section view of a solenoid valve and of rapid connection tubes according to some embodiments described here;

FIG. 3 is a view of the solenoid valve of FIG. 2 in an assembled state;

FIGS. 4 to 7 show some embodiments of the rapid connection tubes according to the invention;

FIG. 8 is a section view of a variant of a solenoid valve with the rapid connection tubes according to the invention inserted;

FIG. 9 is a schematic view of the solenoid valve of FIG. 8;

FIG. 10 is a section view of a solenoid valve with the rapid connection tubes according to a variant of the present invention inserted;

FIG. 11 is an exploded view of the rapid connection tubes of FIG. 10;

FIG. 12 is a three-dimensional view of a self-priming valve according to some embodiments described here;

FIGS. 13 and 14 respectively show the self-priming valve of FIG. 12 in a non-active condition and in an active condition;

FIG. 15 is a section view of a non-return and anti-limescale valve device according to some embodiments described here in a closed condition;

FIG. 16 is a section view of the valve device of FIG. 15 in an open condition;

FIG. 17 is an exploded view of the components of a non-return and anti-limescale valve device according to a variant;

FIG. 18 is a section view of the valve device of FIG. 17 in a closed condition;

FIG. 19 is a section view of the valve device of FIG. 17 in an open condition;

FIGS. 20 and 21 are schematic section views of another variant of the non-return and anti-limescale valve device, respectively in a closed and in an open condition;

FIG. 22 is a schematic view of a machine for preparing coffee beverages according to a variant of the invention.

To facilitate comprehension, the same reference numbers have been used, where possible, to identify identical common elements in the drawings. It is understood that elements and characteristics of one embodiment can conveniently be combined or incorporated into other embodiments without further clarifications.

### DETAILED DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

Some embodiments described here with reference to the attached drawings concern a machine 10 of the automatic type for preparing coffee beverages, in particular suitable to prepare both low-pressure coffee beverages, such as an American type coffee, also defined as “Drip”, or “Coffee”, and high-pressure coffee beverages, such as an “Espresso” type coffee.

The machine 10 comprises a brewing unit 11 provided with a brewing chamber 12 suitable to contain a dose of coffee powder to be brewed.

The machine 10 also comprises a water feed circuit 13 configured to feed water from a source 14 to the brewing chamber 12, and a beverage exit circuit 15 by means if which the beverage exits from the brewing chamber 12 and can be fed to a delivery nozzle 16.

According to some embodiments, the water source can be a tank 14, or a connection to a water mains network.

Along the water feed circuit 13 there can also be provided a feed pump 17 and a heating device 18, for example a boiler, provided with heating means 19, for example comprising one or more electric resistances, suitable to heat the water flow before it reaches the brewing chamber 12.

Along the water feed circuit 13 there can also be provided detection devices, suitable to detect one or more parameters of the water flow in transit, for example a flow meter 20, preferably located upstream of the feed pump 17, and/or temperature sensors 21 located downstream and/or upstream of the heating device 18.

According to some embodiments, the brewing chamber 12 comprises an entry aperture 22 in communication with the water feed circuit 13 and an exit aperture 23 in communication with the beverage exit circuit 15.

The entry 22 and exit 23 apertures are preferably made on opposite sides of the brewing chamber 12; even more preferably, one on a fixed body 24 and the other on a mobile piston 25.

The present invention concerns both machines 10 which provide to feed the water from above and to extract the beverage from below, and also machines which function with water feed and extraction in the opposite way.

According to some embodiments, the machine 10 comprises a delivery valve 26 located upstream of the entry aperture 22, configured to keep the feed circuit 13 closed as long as the water being fed does not exceed a determinate pressure value, and to allow the delivery into the brewing chamber 12 when this value is exceeded.

By way of example, the delivery valve 26 can be configured to contrast a maximum pressure of about 3 bar, preferably comprised between 1 and 3 bar.

The delivery valve 26 can also be configured to act as a non-return valve, so as to prevent the water in the brewing chamber 12 from returning backward along the feed circuit 13.

According to some embodiments, the machine 10 comprises a valve unit 35 connected to the exit circuit 15 downstream of the brewing chamber 12 and configured to define a first high-pressure exit path 27 for an “Espresso” type coffee and a second low-pressure exit path 28 for a “Drip” type coffee.

The valve unit 35 comprises an entry 31a and an exit 31b, respectively connected to the exit circuit 15 and to a delivery duct 32 for the beverage.

The delivery duct 32 is in turn connected to a delivery nozzle 16 by means of which the beverage can be delivered into a suitable receptacle 110.

The delivery of the “Drip” type coffee is characterized by the reduced or total lack of cream. A determining factor in the creation of cream is the turbulence of the liquid in the path after extraction up to delivery.

The circuit downstream of the brewing chamber 12 has been designed so that the path of the coffee from the exit 23 to the delivery into the cup encounters reduced variations in diameter/section by means of suitable measures in the hydraulic connections, as will be explained below.

According to some embodiments, the valve unit 35 comprises counter pressure means 33, 133 suitable to supply a desired counter pressure force, and bypass means 34, 134 selectively drivable to bypass the action of the counter pressure means 33, 133.

According to some embodiments, the machine 10 can comprise a control and command unit 100 configured to receive an indication regarding the beverage to be prepared, that is, “Coffee” or “Drip” type coffee to be prepared at low pressure, or “Espresso” type coffee to be prepared at high pressure, and to drive the bypass means 34, 13 accordingly.

The indication regarding the beverage to be prepared can be received as a result of a selection made by a user by means of a command interface, not shown.

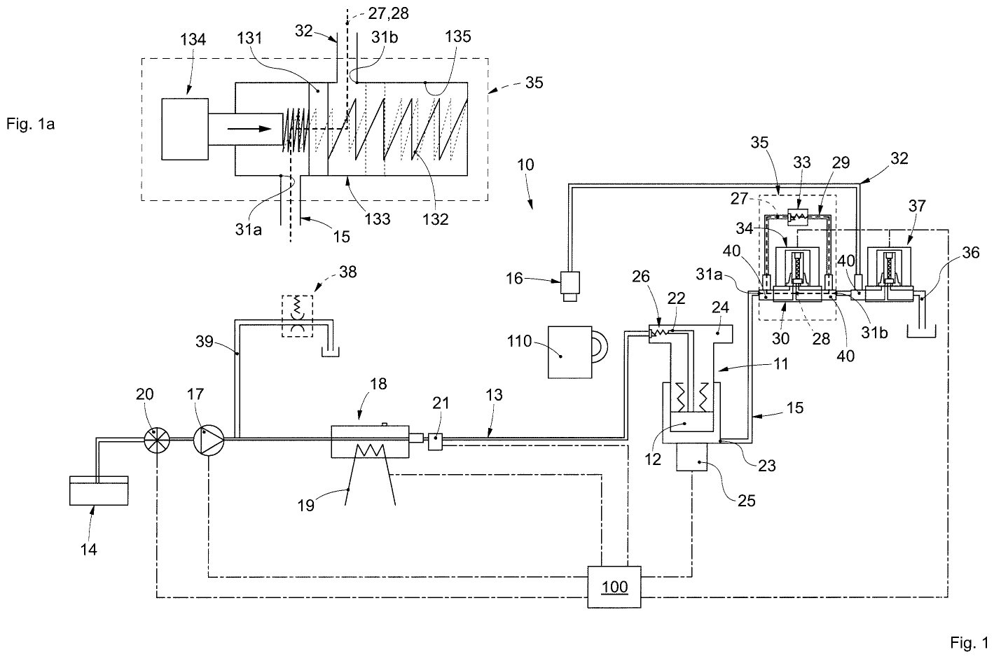

According to some embodiments, for example described with reference to FIG. 1, the high-pressure path 27 and the low-pressure path 28 are defined respectively by a first branch 29 and by a second branch 30, distinct from each other, which develop between the entry 31a and the exit 31b.

According to this solution, the counter pressure means can comprise a cream whipper valve 33 disposed along the first branch 29 and configured to allow the beverage to transit through it only if the pressure exceeds a defined threshold value, in order to obtain a beverage with organoleptic characteristics that are similar to an “Espresso” type coffee.

By way of example, the cream whipper valve 33 can be configured to contrast a maximum pressure of about 3 bar, preferably comprised between 1 and 3 bar.

The bypass means can comprise an interception valve 34 disposed along the second branch 30 which is selectively commandable to open or close a passage duct and allow, or respectively prevent, the transit of the beverage through the second branch 30.

The interception valve 34 can be, for example, a solenoid valve.

In the event that a beverage to be prepared at high pressure is selected, the control and command unit 100 will command the interception valve 34 so as to close the second branch 30, forcing the coffee beverage to necessarily transit through the first branch 29.

On the contrary, in the event that a beverage to be prepared at low pressure is selected, the control and command unit 100 will command the interception valve 34 so as to open the second branch 30 through which the beverage that reaches the delivery nozzle 16 passes, while the first branch 29 is closed by the cream whipper valve 33.

According to alternative embodiments, for example described with reference to FIG. 1 a, it can also be provided that the high-pressure path 27 and the low-pressure path 28 share a same duct along the entire path between the entry 31a and the exit 31b.

According to this solution, the pressure generating means can comprise a cream whipper valve 133 positioned along the common duct, which can assume an active conformation, in which it is configured to keep the duct closed as long as the pressure of the beverage does not exceed a determinate threshold value, so as to allow the generation of cream/foam typical of beverages at high pressure, and a non-active conformation in which it keeps the passage in the duct for the other types of beverages at low pressure open.

The cream whipper valve 133 can comprise a housing 135 provided with an entry 31a and an exit 31b, a mobile piston 131 disposed in the housing 135 and elastic return means 132 suitable to exert a thrust on the mobile piston 131 in such a way as to position it upstream of the exit 31b, preventing the transit of the fluid.

In this case, the bypass means can comprise drive means 134, for example a mechanical actuator or suchlike, suitable to act on the mobile piston 131 in order to displace it downstream of the exit 31b, nullifying the effect of the elastic return means 132.

According to these embodiments, the cream whipper valve 133 can be put in the non-active conformation by means of the drive means 134 commanded by the control and command unit 100, when the preparation of a beverage at low pressure is selected.

According to some embodiments, the machine 10 can also comprise a discharge circuit 36 for the residual water deriving from the exhausted coffee powder.

According to some embodiments, the discharge circuit 36 can be made deriving from the common delivery duct 32 and be kept normally closed by means of a discharge solenoid valve 37 disposed along it.

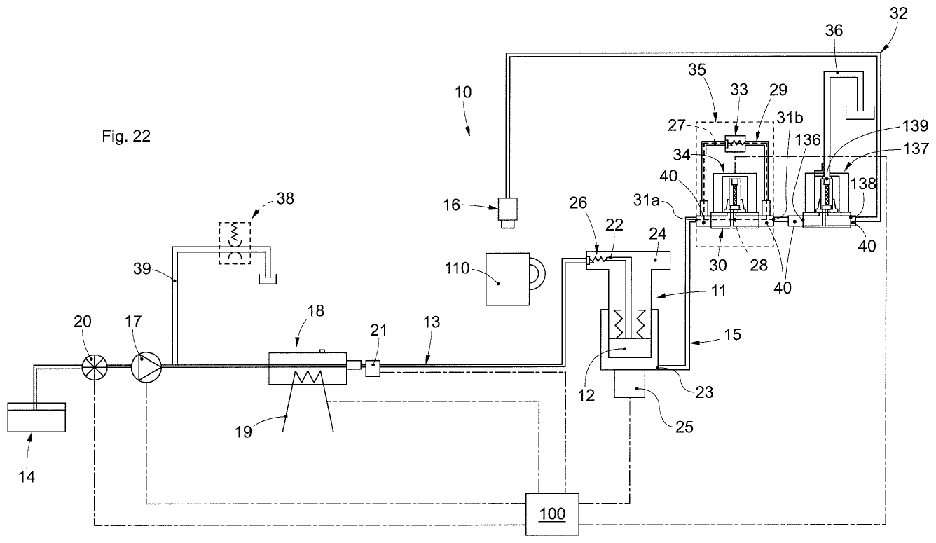

According to possible variants, for example described with reference to FIG. 22, along the delivery duct 32 downstream of the valve unit 35, there can be provided a three-way solenoid valve 137 provided with an entry 136 and two exits 138, 139, wherein a first exit 138 is aligned with, and connected to, the delivery duct 32, while a second exit 139 is connected to the discharge circuit 36.

According to some embodiments, at least the low-pressure path 28 has, at least for most of its extension, a substantially constant passage section for the beverage, that is, substantially free of restrictions or variations in diameter that could cause turbulences and generate air bubbles.

The present invention also concerns rapid connection tubes 40, 140 which have a substantially constant passage section for the fluid and can be advantageously connected to a transit channel 42 of a solenoid valve 34, 37, 137, or possibly of a pump 17, even of a known type.

The solenoid valves 34, 37, 137 commonly used in applications requiring passage sections for fluids of the order of a few millimeters, for example 3-5 mm in diameter, comprise a valve body 41 provided internally with a transit channel 42, a mobile shutter body 43 and a drive member 44 to move the shutter body 43 and selectively open and close the transit channel 42.

For the connection of the tubes/ducts to the solenoid valve 34, known solutions provide to use connection elements, not shown, which are inserted with one end inside the transit channel 42 and clamped therein by means of respective gaskets, in particular O-rings, and pins inserted in suitable coupling seatings 45 (FIG. 3).

Other embodiments (FIG. 8) provide that the connection elements are screwed with a first end into a threaded portion 46 inside the transit channel 42. The connection elements are then inserted with the opposite end inside the tubes and attached by means of attachment elements, such as elastic bands positioned outside the same tubes. The presence of the auxiliary connection elements, however, on the one hand entails long assembly times, since it is necessary to insert both the gaskets and also the pins, or in any case screw the connections, and on the other hand entails a reduction in the area of the passage section of the liquid, which can be particularly relevant in ducts with small sizes, such as those in question. By way of example, the section diameter can decrease from about 3 mm to about 2.2mm, reducing the section area by 46.2%. Furthermore, the reduction of the passage section of the liquid extends over the entire length of the valve body 41 and of the connections, and entails the generation of turbulences in the flow of the beverage, generating unwanted bubbles and foam.

The rapid connection tube 40, 140 according to the invention comprises a tubular body 47, 147 provided with a first head end 47 able, during use, to be inserted inside the transit channel 42, and with a second end 47b, opposite the first.

According to some embodiments, the rapid connection tube 40, 140 can have a length L along the longitudinal axis comprised between about 50 and 100 mm.

The tubular body 47, 147 has an internal channel 48, 148 with a substantially constant section, at least for most of the length L, preferably equal to or greater than 3 mm, for example comprised between 3 and 5 mm.

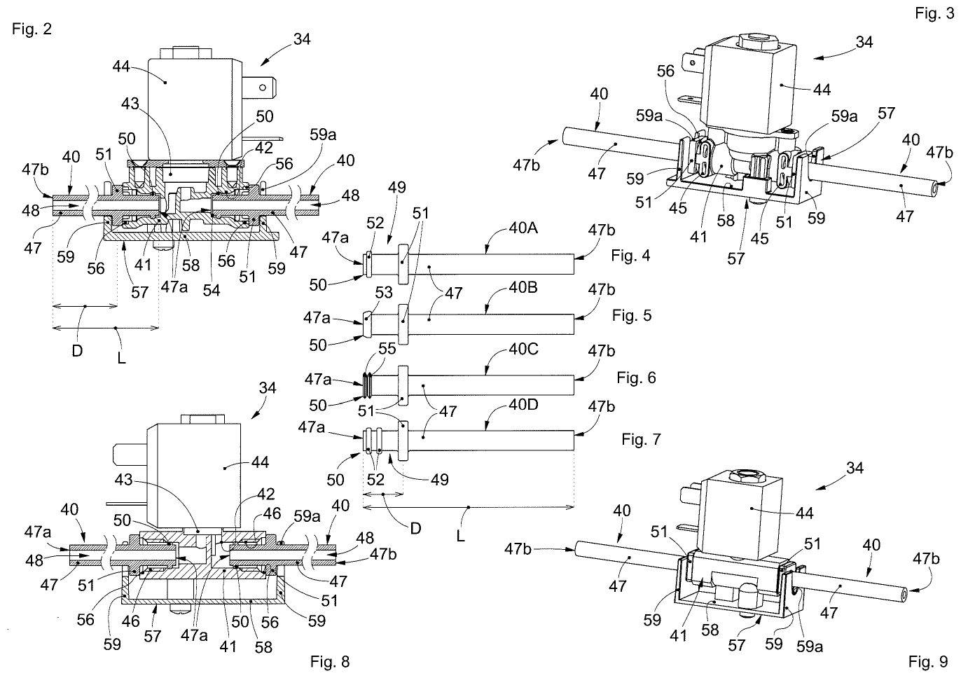

According to some embodiments, for example described with reference to FIGS. 2-9, the tubular body 47 is made in a single body.

Preferably, the internal channel 48 has a constant diameter between the first end 47a and the second end 47b, preferably comprised between 3 and 5 mm.

The rapid connection tube 40 also comprises connection and sealing elements 49 integrated with the tubular body 47.

Preferably, the connection and sealing elements 49 and the tubular body 47 are made in a single body, and with the same material.

According to some embodiments, the tubular body 47 and the connection and sealing elements 49 can be made of at least partly flexible material, for example silicone material.

According to some embodiments, the connection and sealing elements 49 comprise first sealing means 50 configured to cooperate with an internal surface of the transit channel 42 of the solenoid valve 34, and second sealing means 51 disposed, during use, outside the valve body 41 and configured to be positioned in contact with the latter.

According to some embodiments, the second sealing means 51 are disposed along the tubular body 47, distanced by a distance D with respect to the first end 47a, coherent with the depth of the transit channel 42.

By way of example, the distance D can be comprised between about 15 and 20 mm. FIGS. 4 to 7 show four possible embodiments of a rapid connection tube 40 according to the invention, indicated with the letters A, B, C and D, which differ mainly in the shape of the first sealing means 50.

According to some embodiments of the rapid connection tube 40A, 40B, 40C, 40D, the first sealing means 50 comprise an annular portion 52, 53 having a larger section than the average external section of the tubular body 47, with sizes mating with the transit channel 42.

According to possible variants, for example described with reference to FIG. 4, the annular portion 52 can be distanced with respect to the head end 47a and be configured to cooperate, with one of its peripheral edges, with an internal surface of the transit channel 42.

According to some embodiments, the annular portion 53 can be provided in correspondence with the head end 47a, so as to cooperate with an abutment element 54 inside the transit channel 42, producing the hydraulic seal on two sides (FIG. 5).

The annular head portion 53 can have a tapered shape toward the head end 47a. According to some embodiments, the transit channel 42 can have a step-shaped development, in which the section decreases in segments and the annular head portion 53 can be configured to abut against the wall of the last step, or of an intermediate step, which acts as a striker element 54. According to other embodiments, for example described with reference to FIG. 7, two or more annular portions 52 can be provided, disposed distanced from each other between the head end 47a and the second sealing means 51.

According to possible embodiments, the two or more annular portions 52 can have the same radial and/or longitudinal extension.

According to possible variants, the two or more annular portions 52 can have different radial extensions, increasing between the head portion 47a and the second sealing means 51. This embodiment can be used for example in solenoid valves of the type shown in FIG. 2, in which the transit channel 42 has a step-shaped development, so as to create a mechanical seal for each zone with a differentiated section.

According to other embodiments, with reference to FIG. 6, a pair of annular portions can also be provided, for example a pair of gaskets 55, located adjacent to each other.

According to other variants, the first sealing means 50 can also comprise a combination of two or more of either annular portions 52, head portions 53 or gaskets 55, disposed between the head end 47a and the second sealing means 51.

According to some embodiments, the second sealing means can comprise an abutment shoulder 51, having a section larger than an entry aperture 56 of the transit channel 42 of the solenoid valve 34, which abuts on the valve body 41, against the edge of the entry aperture 56.

In this way, given that the connection and sealing elements 49 are integrated directly on the tubular body 47 itself, the rapid connection tube 40 can be inserted directly inside the solenoid valve 34, without needing to provide additional auxiliary connection elements.

The abutment shoulder 51 can cooperate, on the opposite side with respect to the body 41 of the solenoid valve 34, with a support element 57 suitable to keep it in contact with the latter.

According to some embodiments, the support element 57 can be U-shaped, with a bottom wall 58 and two lateral walls 59 parallel to each other, each suitable to cooperate with an abutment shoulder 51 of a respective rapid connection tube 40.

The lateral walls 59 can be distanced from each other by a distance equal to the sum of the length of the valve body 41 and the thickness of the two abutment shoulders 51, so as to clamp the rapid connection tubes 40 in the solenoid valve 34 by means of a same-shape coupling.

According to some embodiments, the lateral walls 59 can each have hollowed portions 59a with a shape matching that of the tubular body 47, which can be disposed, during use, resting on them.

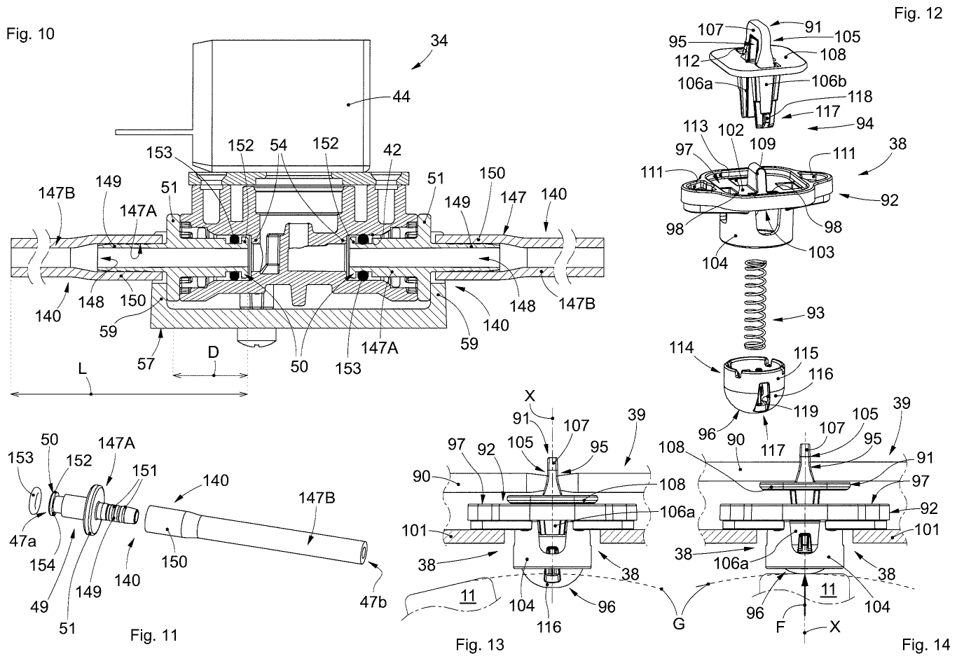

The embodiment of a rapid connection tube 140 shown in FIGS. 10 and 11 differs from the rapid connection tube 40 of FIGS. 2-9 due to the fact that the tubular body 147 is made in two components, that is, a first component 147A configured to be inserted inside the transit channel 42 and to couple to it, and a second component 147B configured to couple to the first component 147A.

The first component 147A can comprise, made on it, the connection and sealing elements 49, or the first 50 and/or the second 51 sealing means, which can be substantially conformed in a similar way to that previously described.

According to some embodiments, the first sealing means 50 can comprise an annular portion 152 located in correspondence with a head end, suitable to abut against a striker element 54 of the transit channel 42.

Downstream of the annular portion 152, the first sealing means 50 can also comprise a seating 154, made in the thickness of the first component 147A and suitable to house a gasket 153, for example an O-ring.

It can also be provided that the annular portion 152 does not abut, exploiting the seal provided by the gasket 153.

The first component 147A has, downstream of the second sealing means 51, an insertion portion 149 having an external diameter smaller than the external diameter upstream of the sealing means 51, in order to allow it to be inserted inside the second component 147B.

The second component 147B, in turn, has a housing portion 50 having a diameter of the internal section greater than the diameter of the internal channel 148, in such a way as to house the insertion portion 149.

In any case, the insertion portion 149 has a diameter of the internal section greater than or equal to 3 mm.

During use, the internal channel 148 defined partly by the first component 147A and partly by the second component 147B therefore has, in any case, a substantially constant diameter, greater than or equal to 3 mm, and preferably comprised between 3 and 5 mm.

According to some embodiments, the first component 147A can be made of rigid plastic material.

The insertion portion 149 can be provided externally with ribs or protruding ridges 151.

The second component 147B can be made of at least partly deformable flexible material, configured to deform when in contact with the ribs/ridges 151 and create a sealed coupling with the first component 147A.

Alternatively, both components 147A, 147B can be made of rigid plastic material and can be coupled by screwing or snap-in coupling means.

In the machine 10 according to the invention, at least the tubes for connection with the solenoid valve 34 and, if present, also with the three-way solenoid valve 137, that is, along the low-pressure path 28, have a substantially constant internal section and they are preferably made with the rapid connection tubes 40, 140.

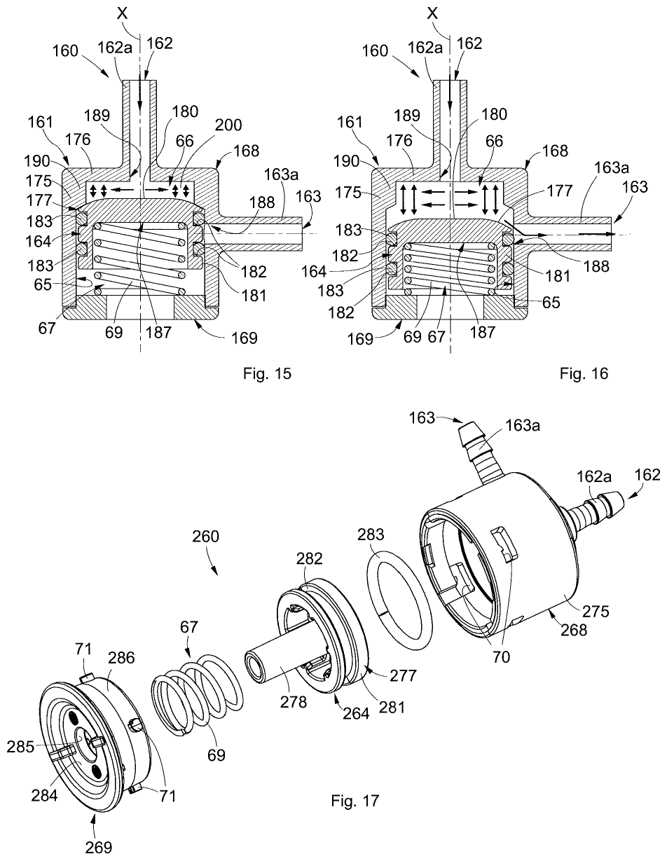

The present invention also concerns a valve device 160, 260, 360 which can be advantageously used both as a delivery valve 26 and also as a cream whipper valve 33 (FIGS. 15-21).

According to a first variant, shown in FIGS. 15 and 16, the valve device 160 comprises an entry aperture 162 and an exit aperture 163 for a fluid, which are connected to respective entry 162a and exit 163a ducts.

The valve device 160 also comprises a chamber 66 which puts the entry 162 and exit 163 apertures in selective communication when the device 160 is in an open condition.

The valve device 160 comprises a valve body 161 which delimits a housing compartment 65, a piston 164 disposed in the compartment 65, mobile with respect to the exit aperture 163 between a first position in which the fluid can pass and a second position in which the fluid is obstructed, and elastic return means 67 associated with the piston 164.

The elastic means 67 are configured to keep the piston 164 in the closed position until a predefined pressure limit is reached in the chamber 66.

The movement of the piston 164 under the action of the pressurized fluid determines, in addition to the opening of the exit aperture 163, also the expansion of the volume of the chamber 66.

In particular, the thrust of the pressurized fluid acting on the mobile piston 164 puts the entry 162 and exit 163 apertures in direct communication.

The entrance 162 and exit 163 apertures are oriented in different directions from each other. Although in FIGS. 15 and 16 they are shown disposed substantially orthogonal to each other, it is not excluded that they can be positioned at different angles, in order to adapt to the connection ducts of the specific application, for example inclined by 45°, or having an L shape or a curved shape, or suchlike.

The elastic means 67 are advantageously located outside the chamber 66, that is, outside the path of the fluid, and the fluid never comes into contact with the elastic means 67. This allows to obtain a plurality of advantages:
the accumulation of limescale in the elastic means 67 is eliminated, extending the life of the valve device 160;
it is possible to use a simple metal helical spring as elastic means 67;
since the elastic means 67 are outside the passage of the fluid, the valve device 160 is much easier to clean, and is also suitable to be used for the transit of a coffee beverage which, as is known, tends to dirty due to the solid residues present in it.

According to some embodiments, the valve body 161 and the mobile piston 164 can be made of plastic material.

The valve body 161 can be formed by an upper half-shell 168 defining the housing compartment 65 for the mobile piston 164 and the elastic means 67, and a lower half-shell 169 configured to couple to the upper half-shell 168 and close the compartment 65 at the lower part.

The upper half-shell 168 cooperates with the piston 164 to delimit the chamber 66, and the lower half-shell 169 keeps the elastic means 67 in position, possibly with a predefined compression.

The upper half-shell 168 can comprise a lateral wall 175 with a cylindrical shape and a top wall 176 having a substantially flat shape, in which an entry hole 189 is made that defines or is connected to the entry aperture 162.

The mobile piston 164 comprises a shutter portion 177 having an upper wall 180 which delimits the chamber 66 at the lower part, and a lateral wall 181 cooperating with the exit aperture 163 or with a hole 188 connected thereto, and having a radial size mating with that of the housing compartment 65, in such a way as be positioned in contact with an internal surface of the latter and to create a hydraulic seal with it.

According to some embodiments, in the closing position of the valve device 160 and in the position of maximum release of the elastic means 67, between an upper surface 180 of the piston 164 and the top wall 176 of the valve body 161 there remains defined a free space 200 that has a width substantially the same as or slightly smaller than that of the housing compartment 65.

The free space 200 is directly facing toward the entry aperture 162 and can therefore be filled with a fluid, in particular a liquid, coming from it.

In this way, the chamber 66 has, on each occasion, a minimum volume Vmin in which a liquid coming from the entry aperture 162 can accumulate and be distributed in contact with the entire upper surface 180 of the piston 164.

By way of example, the minimum volume Vmin of the chamber 66 can be greater than or equal to 10% of the maximum volume that the chamber 66 reaches when the valve device 160 is in a completely open condition. By way of example, the minimum volume Vmin, depending on applications, can be comprised between about 10% and about 60% of the maximum reachable volume, preferably between 15% and 40%.

According to some embodiments, the free space 200 has a width on a plane orthogonal to the central axis X of the piston 164 and to the direction of entry of the fluid equal to at least 80% of the width of the compartment 65, or even greater than it.

According to some embodiments, the top wall 176 can have at least one flat portion disposed substantially parallel to the upper surface 180 of the piston 164, which is also preferably flat, and the free space 200 is defined between them. In this way, the free space 200 can have a depth that is substantially constant along its extension and the fluid can act on both surfaces 180, 176 in order to move the piston 164 away from the exit aperture 163.

In this way, the active surface on which the fluid at entry can act in order to open the valve device 160 is almost doubled with respect to known solutions and therefore allows the valve device 160 to also be used in applications that require low usage pressures, while still guaranteeing a high seal in the closed condition.

According to some embodiments, the entry aperture 162, or possibly the hole 189, can have an area much smaller than the area of the top wall 176, for example comprised between 1/10 and 1/12 of its section, so as to maximize the useful area on which the fluid can act.

According to some embodiments, a groove 182 can be provided in the lateral wall 181 which extends along the circumference and is suitable to house an annular gasket 183, in order to guarantee the hydraulic seal between the mobile piston 164 and the housing compartment 65, preventing possible leakages of fluid.

In the example case, the lateral wall 181 can comprise two grooves 182, each suitable to house a respective annular gasket 183, which are disposed, in the closed condition of the valve device 160, on the opposite sides of the through hole 188, so as to act as a non-return valve, preventing any unwanted leakage of fluid coming from the exit aperture 163.

According to other variants, not shown, the lateral wall 181 can itself act as a head gasket, and can be at least partly made of deformable material, so as to cooperate directly with the lateral wall 175. This solution has the advantage of guaranteeing a seal for longer periods of time since, unlike the annular gasket which can be damaged over time due to the interference with the edge of the exit aperture 163, the head gasket does not have such problems.

The conformation of the valve device 160 prevents the fluid from entering in the valve body 161 from the exit aperture 163, whatever the pressure of the fluid, and is therefore extremely effective as a non-return valve. Furthermore, the pressure of the fluid entering from the exit aperture 163 will tend to increase the seal of the annular gasket/s 183 or of the head gasket 181.

According to some embodiments, in the proximity of the entry aperture 162 the housing compartment 65 has a portion with a smaller diameter, defining a shoulder 190 configured to act as a striker and abutment element for the piston 164, so as to ensure that even in the closed condition of the valve device 160 the chamber 66 always has a minimum volume suitable to allow a determinate quantity of fluid to accumulate, that is, the free space 200.

The piston 164 can comprise at the lower part a cavity 187 suitable to at least partly house the elastic means 67 and keep them in position.

FIGS. 15 and 16 show respectively the valve device 160 in the closed condition and in the open condition.

As can be seen in FIG. 15, in the closed condition the lateral wall 181 is placed to close the through hole 188 and therefore the exit aperture 163, and prevents the transit of the fluid through the latter.

The fluid enters through the entry aperture 162 directly into the chamber 66 between the upper wall 180 and the top wall 176, following the path indicated by the arrows in FIG. 15, and fills the free space 200.

As the pressure of the fluid gradually increases, it will tend to exert a force on both walls 180, 176, until the force exerted is sufficient to overcome the elastic force of the elastic means 67, thrusting the mobile piston 164 in such a way as to move it at least partly away from the through hole 188, and take the valve device 160 into the open condition (FIG. 16) putting the chamber 66 in communication with the exit aperture 163.

When the pressure of the fluid decreases and is no longer able to contrast the force supplied by the elastic means 67, these extend taking the piston 164 back to the closing position.

FIGS. 17-19 show a second embodiment of a valve device 260, which has a conformation similar to that of the first embodiment of FIGS. 15-16. The elements identical to the valve device 160 are indicated with the same reference numbers, possibly increased by one hundred, and are not described further.

The valve device 260 comprises a valve body 261 on which through holes 189, 188 are made that directly define, or are connected by respective ducts 162a and 163a to, the entry 162 and exit 163 apertures.

The valve body 261 can comprise an upper half-shell 268 with which the entry 162 and exit 163 apertures are associated, and a lower half-shell 269 having a lower wall 284 and a lateral wall 286 with a substantially cylindrical shape, suitable to be inserted, during use, at least partly inside the upper half-shell 268.

The two upper 268 and lower 269 half-shells can be provided with respective mating coupling members 70, 71, configured to cooperate with each other. By way of example, the coupling members can comprise respective protruding elements 71 and mating clamping seatings 70 made on the respective lateral walls 275, 286 of one or the other of the half-shells 268, 269, which are suitable to produce a same-shape mechanical coupling. Coupling members of different types can also be provided, for example of the bayonet-type, or by means of threaded portions.

The valve device 260 also comprises a mobile piston 264 provided with a shutter portion 277 comprising an upper wall 280 which delimits the chamber 66 at the lower part, and a lateral wall 281 which acts as a shutter portion and cooperates with the through hole 188 defining, or being connected to, the exit aperture 163.

In this second embodiment, the mobile piston 264 also comprises a rod 278 which extends from the opposite side of the shutter portion 277 with respect to the upper wall 280, and has a section suitable to be inserted into a through hole 285 made in the valve body 261, in this specific case in the lower half-shell 269.

The hole 285 acts as a guide for the mobile piston 264 which therefore remains aligned along a central axis in any condition of use, so as to ensure the seal of the chamber 66 in any condition of use.

In this embodiment, the elastic means 67 can comprise a helical spring 69 disposed around the rod 278, with one end resting on a lower wall 284 and the opposite end inserted in a cavity 287 made in the shutter portion 277.

According to this embodiment, the mobile piston 264 has a radial size corresponding to the internal section of the housing compartment 65, and in the closed condition of the valve device 260 and in the position of maximum release of the elastic means 67, between the upper portion 280 and the top wall 276 of the compartment 65 there remains defined a free space 200 which also in this case has an extension substantially equal to the width of the compartment 65 and is directly facing the entry aperture 162.

Preferably, in the proximity of the entry aperture 162 the housing compartment 65 has a shoulder 190 configured to act as a striker and abutment element for the piston 264 in the closed position of the valve device 260, such as to ensure that the free space 200 is maintained.

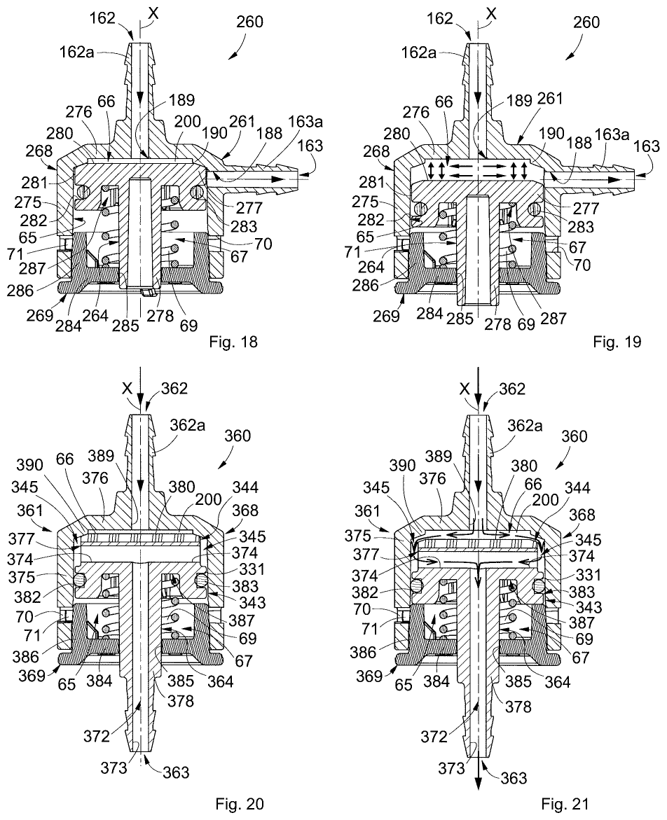

The fluid enters through the entry aperture 162 directly into the chamber 66 between the upper wall 280 and the top wall 276, following the path indicated by the arrows in FIG. 18, and it accumulates in the free space 200.

As the pressure of the fluid gradually increases, it will tend to exert a force on both walls 280, 276, until the force exerted is sufficient to overcome the elastic force of the elastic means 67, thrusting the mobile piston 264 in such a way as to move it at least partly away from the through hole 188, and take the valve device 260 into the open condition (FIG. 19) putting the chamber 66 in communication with the exit aperture 163.

When the pressure of the fluid decreases and is no longer able to contrast the force supplied by the elastic means 67, these extend taking the piston 264 back to the closing position.

Also in this case, at least one groove 282 can be made in the lateral wall 281 suitable to house a gasket 283 in order to ensure the seal of the chamber 66.

FIGS. 20 and 21 show a third embodiment of a valve device 360. The elements identical to the valve device 160 are indicated with the same reference numbers and are not described further. Similar but different elements are indicated with the same number, increased by two hundred.

According to this embodiment, the entry aperture 362 and the exit aperture 363 are disposed coaxial to each other and with respect to the sliding axis X of the mobile piston 364, on opposite sides of the valve body 361.

The lower half-shell 369 can be substantially similar to that described with reference to the second embodiment of FIGS. 18-19, while the upper half-shell 368 in this embodiment only has the entry aperture 362.

Also in this case, in the condition of maximum extension of the elastic means 67 there remains defined a free space 200, that is, the minimum volume of the chamber 66, which is directly facing the entry aperture 362.

In the third embodiment, the mobile piston 364 comprises a shutter portion 377 provided with an upper surface 380 which delimits the chamber 66, and a rod 378 that extends from the side opposite the upper surface 380.

The upper wall 380 is substantially flat and extends parallel to the top wall 376, so that the free space 200 has a substantially constant depth and an extension at least equal to the opposite surfaces of the two walls 280, 276,

The mobile piston 364 is at least partly hollow and comprises inside it a transit channel 372 for the fluid, which extends between at least one entry 374 made through in the shutter portion 377 and an exit 373 made at the end of the rod 378, which defines the exit aperture 363.

According to this embodiment, the elastic means 67 are positioned around at least one part of the rod 378, with one end disposed in a cavity 387 made in the shutter portion 377 and the opposite end in contact with a bottom wall 384 of the valve body 361.

According to this embodiment, the shutter portion 377 comprises a larger portion 343, connected to the rod 328, having a section substantially the same as the section of the housing compartment 65, and a smaller portion 344 on which the at least one entry 374 is provided, having a smaller section than the housing compartment 65 and defining with an internal wall of the latter a channel 345 for the passage of the fluid from the free space 200 to the at least one entry 374.

According to the embodiment of FIGS. 20-21, the internal surface of the top wall 376 can have a shoulder 390 in correspondence with its peripheral portion, which acts as an abutment for the upper wall 380 of the piston 364 in the closing position, so as to close the passage channel 345 for the fluid and define the free space 200.

According to this embodiment, it can be provided that the smaller portion 344, or at least the part thereof defining the upper wall 380, is made of rubber in order to ensure the seal of the valve device 360 in the closed condition, when the elastic means 67 thrust the upper wall 380 against the shoulder 390.

As can be seen in FIG. 20, in the closed condition, the upper wall 280 is positioned in abutment against the shoulder 390 and closes the passage channel 345, preventing the fluid from reaching the entry 374.

The fluid enters the chamber 66 through the entry aperture 362 in a direction concordant with the direction of compression of the elastic means, along the central axis X, it accumulates in the free space 200 until it reaches a determinate pressure sufficient to compress the elastic means 67 and move the head of the piston 364 away from the shoulder 390, so as to open the channel 345 for the passage of the fluid toward the transit channel 372 through which it reaches the exit aperture 363 (FIG. 21).

According to some embodiments, the machine 10 can also comprise a self-priming valve 38 disposed along a duct 39 located downstream of the pump 17 and deriving from the water feed circuit 13.

According to some embodiments, the self-priming valve 38 can be made as a pinch valve.

According to the embodiments described with reference to FIGS. 12-14, the self-priming valve 38 can comprise at least a first body 91 and a second body 92 functionally associated with each other in such a way as to define between them a passage gap 95 in which, during use, a flexible tube 90 of the duct 39 is positioned.

The first body 91 and the second body 92 are slidingly coupled to each other in such a way as to allow a reciprocal sliding along a sliding axis X.

According to some embodiments, the passage gap 95 is comprised in a plane parallel to the sliding axis X.

The second body 92 is preferably attached to a support structure 101 inside the machine 10, while the first body 91 is configured mobile with respect to the second body 92. For example, the second body 92 can be provided with through holes 111 suitable to cooperate with attachment means of the known type, such as pins, screws, or suchlike, to allow the attachment thereof to the support structure 101.

The self-priming valve 38 can comprise elastic means 93 associated with the second body 92 on an opposite side with respect to the passage gap 95, which are configured to maintain the self-priming valve 38 in a closed operating configuration.

The self-priming valve 38 also comprises an actuation portion 96 that can be driven to axially move the first body 91 toward an open operating configuration, counteracting the action of the elastic means 93.

According to some embodiments, the first body 91 and the second body 92 comprise mating guide means 94.

According to some embodiments, for example described with reference to FIGS. 12 to 14, the second body 92 comprises a flat portion 97 provided with through holes 98, which define part of the guide means 94.

The flat portion 97 comprises a first surface 102 facing toward the passage gap 95 and a second surface 103, opposite the first surface 102, which cooperates with the elastic means 93.

The second body 92 can also comprise a tubular portion 104, extending from the second surface 103 which, during use, acts as a housing for the elastic means 93.

The first body 91 can have a U-shaped housing portion 105, which partly delimits the passage gap 95.

The housing portion 105 can comprise two longitudinal segments 106a, 106b, which extend parallel to the sliding axis X, and a transverse segment 107, which is orthogonal to the longitudinal segment 106a, 106b and joins them at the ends.

The longitudinal segments 106a, 106b are slidingly inserted in the through holes 98 and can have sections which are substantially mating in shape.

The first body 91 can also comprise a flat abutment portion 108, disposed transversely with respect to the longitudinal segments 106a, 106b, distanced from the transverse segment 107.

The passage gap 95 is therefore closed on the entire perimeter, being disposed in a ring around the flexible tube 90 when in use, being delimited by the transverse segment 107, by the abutment portion 108, partly, by the longitudinal segments 106a, 106b and by the second body 92.

According to other embodiments, the first surface 102 has a central seating 113 suitable to at least partly house the abutment portion 108.

According to some embodiments, the second body 92 comprises an interference element 109 protruding from the first surface 102, configured to cooperate with the transverse segment 107 in order to deform the flexible tube 90 positioned in the passage gap 95.

According to these embodiments, it can be provided that the abutment portion 108 has a through hole 112 suitable to allow the passage of the interference element 109 therein.

The interference element 109 can be disposed transversely between two opposite through holes 98, parallel to the transverse segment 107.

According to some embodiments, the transverse segment 107 and the interference portion 109 have a rectilinear development with a reduced width, of the order of 1-3 mm, in such a way as to exert a concentrated and punctual force from opposite sides of the flexible tube 90.

According to some embodiments, the self-priming valve 38 comprises a closing element 114 integrated with, or connected to, the first body 91 and in particular to the ends of the longitudinal segments 106a, 106b opposite the transverse segment 107.

The closing element 114 acts as an abutment element for the elastic means 93. The actuation portion 96 is defined by an end portion of the closing element 114.

In this way, when the self-priming valve 38 is not subjected to any stress, the elastic means 93 thrust the closing element 114 away from the second body 92, consequently taking the transverse segment 107 closer to the first surface 103 and to the interference portion 109 in order to reduce the section of the passage gap 95 and obstruct the flexible tube 90 therein.

On the other hand, when a force F is exerted on the actuation portion 96 toward the second body 92, in the sense indicated by the arrow in FIG. 14, the closing element 114 compresses the elastic means 93 while the transverse segment 107 is moved away from the first surface 103 and from the interference portion 109, widening the passage gap 95.

According to some embodiments, the closing element 114 can have a tubular portion 115, preferably cylindrical, closed at one end by a shaped portion 116, preferably rounded, or semi-spherical, which defines the actuation portion 96.

According to some embodiments, the first body 91 and the closing element 114 are provided with respective coupling means 117 suitable to define a reciprocal stable coupling between the two components, for example a coupling by interference, a same-shape or snap-in coupling.

The coupling means 117 can comprise coupling elements 118, such as protruding teeth provided on the longitudinal segments 106a, 106b of the first body 91, and respective coupling seatings 119 provided on the closing element 114, which are configured to receive and cooperate with the coupling elements 118.

According to some embodiments, the self-priming valve 38 can be selectively driven by the movement of the mobile brewing unit 11.

For example, according to some embodiments, the self-priming valve 38 can be configured to be positioned along a trajectory G traveled by the mobile brewing unit 11, or by one of its components, and the self-priming valve 38 can be activated when the brewing unit 11 is in a determinate position in which it interferes with it.

For example, it can be provided that the self-priming valve 38 is activated when the brewing unit 11 is in correspondence with its lower end-of-travel position.

As a function of the shape and disposition of the components of the machine 10, however, a different activation position can be provided, for example in an intermediate loading position between the lower end-of-travel position and an upper end-of-travel position.

According to some embodiments, the activation of the self-priming valve 38 determines its opening for discharge, putting the exit of the pump 17 in communication with the atmospheric pressure, in such a way as to allow the escape of any air bubbles.

If, during the functioning of the machine 10, the suction of water from the tank 14 is not detected, the beverage preparation cycle is interrupted, and the brewing unit 11 returns to the lower end-of-travel position, or to an intermediate position, automatically determining the opening of the self-priming valve 38.

According to some embodiments, in the event that the cycle is canceled due to lack of water, the generation of a visual or audible alarm can be provided, in order to inform the user that it is necessary to fill the tank 14.

Once confirmation of the presence of water has been received, the cycle can be started again.

Since the self-priming valve 38 remains active while the brewing unit 11 is in the lower end-of-travel position, in this case any air bubbles present in the pump 17 can be directly eliminated and therefore it is possible to proceed with starting the pump 17 and preparing a coffee beverage.

Some embodiments described here also concern a method to prepare a coffee beverage by brewing a dose of coffee powder in a brewing chamber.

The method comprises receiving an indication of a type of coffee beverage chosen between a beverage to be prepared at high pressure and a beverage to be prepared at low pressure, for example supplied by a user by means of an interface. In particular, the selection of an “Espresso” type coffee will result in an indication of a beverage at high pressure, while the selection of a “Drip” or “Coffee” type coffee will result in an indication of a beverage at low pressure.

The method according to the invention provides to feed hot water to the brewing chamber 12 by means of the water feed circuit 13, suitably activating the pump 17 and the heating device 18, in such a way as to extract the aromatic substances from the coffee powder.

In the event that the preparation of a beverage at high pressure is requested, the method provides to deliver the beverage along a high-pressure exit path 27 of the valve unit 35, making it transit through the counter pressure means 33, 133. In this way it, is guaranteed that the coffee beverage is delivered only if it has reached a pressure sufficient to contrast that of the counter pressure means 33, 133, allowing to obtain the generation of the cream as required for “Espresso” type coffee beverages.

On the contrary, when the preparation of a beverage at low pressure is requested, the method provides to drive the bypass means 34, 134 of the valve unit 35 to bypass the counter pressure means 33, 133 and deliver the coffee beverage along the low-pressure exit path 28.

According to some embodiments, for the preparation of a beverage at high pressure, the method according to the invention provides to drive the solenoid valve 34 disposed along the second branch 30 in such a way as to keep it closed and force the beverage to transit through the cream whipper valve 33 disposed along the first branch 29, while for the preparation of a beverage at low pressure it provides to drive the solenoid valve 34 in order to open the second branch 30, allowing the beverage to transit through it toward the delivery nozzle 16.

According to one variant, for the preparation of a beverage at low pressure, the method provides to drive the actuator element 134 in such a way as to put the cream whipper valve 133 in an active conformation, suitable to define the high-pressure exit path 27, while for the preparation of a beverage at low pressure it provides to drive the actuator element 134 in such a way as to put the cream whipper valve 133 in a non-active conformation, defining the low-pressure exit path 28.

According to some embodiments, during the preparation of a beverage at low pressure, it can be provided to use a first quantity of coffee powder, for example comprised between 8 and 10 g per dose of beverage, and to feed the water with a flow rate comprised between about 2 and 4.2 cc/sec, so as to guarantee a correct extraction of the aromas and a total percentage of dissolved solids comprised between about 1.30% and 1.55%. The machine 40 is in particular configured to regulate on each occasion the quantity of coffee powder and the quantity of water to be fed, and possibly the flow rate, as a function of the quantity of beverage chosen by the user, for example a cup, a mug, half a carafe, or other.

In the case of a beverage at high pressure, the method can provide to increase the quantity of coffee powder per dose of beverage, using a second quantity, for example comprised between 10-12 g, and to compress the coffee powder, and on the other hand reduce the water flow rate, for example around 1 cc/sec, in such a way that it remains in contact with the coffee powder for a longer period of time.

According to other embodiments, at the end of the delivery of the coffee beverage, the method provides to compress the exhausted powder in the brewing chamber 12, for example by moving the mobile piston 25 with respect to the fixed body 24, and to drive the discharge solenoid valve 37, 137 in order to allow the residual water to transit along the discharge circuit 36.

In particular, in the event that the valve unit 35 comprises the first and second branches 29, 30, the method provides, during the compression and discharge operations, to drive the interception solenoid valve 34 in order to block the second branch 30 and make the water also transit along the first branch 29, that is, through the cream whipper valve 33, so as to clean the latter.

It can also be provided that, in the event that there are two branches 29, 30 in the valve unit 35, the discharge water is made to transit, on each occasion, along the same branch 29, 30 used for the beverage.

If the three-way solenoid valve 137 is present along the beverage delivery duct 32, the method provides, during the preparation of a beverage, to drive the three-way solenoid valve 137 in such a way as to keep the first exit 138 open and the second exit 139 closed.

At the end of the preparation of the beverage, the method provides to drive the three-way solenoid valve 137 in order to close the first exit 138 and open the second exit 139, allowing the residual water to be discharged along the discharge circuit 36.

It is clear that modifications and/or additions of parts may be made to the machine 10 and to the method to prepare coffee beverages as described heretofore, without departing from the field and scope of the present invention as defined by the claims.

In the following claims, the sole purpose of the references in brackets is to facilitate reading: they must not be considered as restrictive factors with regard to the field of protection claimed in the specific claims.

1. An automatic machine for preparing coffee beverages, comprising a brewing unit provided with a brewing chamber connected to a feed circuit for the water by means of an entry aperture and to an exit circuit for the beverage by means of an exit aperture, comprising a valve unit, provided with an entry connected to said exit circuit and with an exit connected to a delivery duct, configured to supply a first high-pressure exit path comprising counter pressure means and a second low-pressure exit path comprising bypass means selectively drivable in order to bypass the action of said counter pressure means and make the beverage pass in said second exit path.

2. The automatic machine as in claim 1, wherein between said entry and said exit are provided said first high-pressure exit path and said second low-pressure exit path which are defined respectively by a first branch in which said counter pressure means are provided having a cream whipper valve, and by a second branch in which said bypass means are provided comprising an interception valve.

3. The automatic machine as in claim 2, wherein said cream whipper valve comprises an entry aperture and an exit aperture for a fluid, a chamber that puts said entry and exit apertures in selective communication, a housing compartment, a piston disposed in said compartment, which is mobile between a closing position in which it prevents the transit of the fluid and an opening position in which it allows the passage of the fluid, and elastic return means associated with said piston, outside said chamber.

4. The automatic machine as in claim 1, wherein said high-pressure exit path and said low-pressure exit path share the same circuit branch, wherein said counter pressure means comprise a cream whipper valve and said bypass means comprise drive means selectively commandable to keep said cream whipper valve in a non-active configuration.

5. The automatic machine as in claim 1, comprising a control and command unit configured to receive an indication regarding a type of beverage to be prepared, and consequently drive said bypass means.

6. The automatic machine as in claim 1, comprising at least said second low-pressure path has, at least for most of its extension, a passage section for the beverage that is substantially constant, that is, substantially free of restrictions or variations in diameter that could cause turbulences and generate air bubbles.

7. The automatic machine as in claim 2, comprising rapid connection tubes connected to said interception valve and defining said second branch, said tubes comprising a tubular body provided with a first head end able, during use, to be inserted inside a transit channel provided in a valve body of said interception valve, and a second end, opposite the first end, and connection and sealing elements integrated with said tubular body.

8. The automatic machine as in claim 6, wherein said connection and sealing elements comprise first sealing means disposed in the proximity of said first head end and configured to cooperate with an internal surface of said transit channel, and second sealing means disposed, during use, outside of and in contact with said valve body and configured to cooperate with a support element of said interception valve.

9. The automatic machine as in claim 7, characterized in that said connection and sealing elements and said tubular body are made in a single body and with the same, at least partly flexible, material, such as a silicone material.

10. The automatic machine as in claim 7, characterized in that said tubular body is made in two components, that is, a first component, provided with said connection and sealing elements and configured to be inserted inside the transit channel, and to couple to it, and a second component, configured to be coupled to the first component.

11. The automatic machine as in claim 7, wherein said tubular body has an internal channel having a substantially constant section, preferably equal to, or greater than, 3 mm.

12. The automatic machine as in claim 1, comprising a delivery valve located downstream of said entry aperture, comprising an entry aperture and an exit aperture for a fluid, a chamber that puts said entry and exit apertures in selective communication, a housing compartment, a piston disposed in said compartment, which is mobile between a closing position in which it prevents the transit of the fluid and an opening position in which it allows the passage of the fluid, and elastic return means associated with said piston, outside said chamber, wherein even in the closed condition of said delivery valve and in the condition of maximum release of the elastic means in said compartment there remains in any case defined a free space defining a minimum volume of said chamber.

13. A method to prepare a coffee beverage by brewing a dose of coffee powder in a brewing chamber, wherein said method comprises:
receiving an indication of a type of coffee beverage chosen between a beverage to be prepared at high pressure having organoleptic characteristics similar to an “Espresso” coffee, and a beverage to be prepared at low pressure having organoleptic characteristics similar to a “Drip” coffee;
feeding water to said brewing chamber through an entry aperture and making the beverage exit from said brewing chamber through an exit aperture connected to an exit circuit; and
making the coffee beverage transit through a valve unit downstream of the exit duct,
wherein, if the preparation of a beverage at high pressure is required, said method provides to deliver the beverage along a high-pressure exit path of said valve unit making it transit through counter pressure means and,
if the preparation of a beverage at low pressure is required, said method provides to drive bypass means of said valve unit in order to bypass the action of said counter pressure means and deliver the coffee beverage along a low-pressure exit path.

14. The method as in claim 13, wherein for the preparation of a beverage at high pressure it provides to drive an interception valve disposed along a second branch of said valve unit so as to keep it closed and force the beverage to transit through a cream whipper valve disposed along a first branch, and for the preparation of a beverage at low pressure it provides to drive said interception valve in order to open said second branch allowing the beverage to transit through it.

15. The method as in claim 13, wherein for the preparation of a beverage at high pressure it provides to drive an actuator element so as to put a cream whipper valve of said valve unit in an active conformation, suitable to define said high-pressure exit path, and for the preparation of a beverage at low pressure it provides to drive said actuator element so as to put said cream whipper valve in a non-active conformation, defining said low-pressure exit path.

16. The method as in claim 1, wherein for the preparation of a beverage at low pressure it provides to use a first dose of coffee powder, and to feed the water with a flow rate comprised between 2 and 4.2 cc/sec, so as to guarantee a correct extraction of the aromas, and a total percentage of dissolved solids comprised between about 1.30% and 1.55%, while for the preparation of a beverage at high pressure, the method provides to use a second quantity of coffee powder, greater than the first quantity, and to reduce the flow rate of the water to about 1 cc/sec, so that the water remains in contact with the coffee powder for a greater amount of time.
